(19) United States
(12) Patent Application Publication
(10) Pub. No.: US 2005/0200597 A1
(43) Pub. Date: Sep. 15, 2005

(54) METHOD FOR DETECTING THE POSITION OF A DIGITIZER ON A DISPLAY

(76) Inventors: Shao-Chih Peng, Hsin-Chu Hsien (TW); Jeng-Feng Lan, Hsin-Chu City (TW); Chun-Huang Lin, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,302

(22) Filed: Dec. 26, 2004

(30) Foreign Application Priority Data
Mar. 11, 2004 (TW) 093106530

(51) Int. Cl. G09G 5/00

(52) U.S. Cl. 345/156

(57) ABSTRACT

A computer system includes a display, a graphics chip capable of controlling the display and modulating light signals emitted from a plurality of sub-blocks in a main block on the display sequentially according to a predetermined rule, a digitizer comprising a light signal detecting module which is capable of detecting a light signal emitted from the display and sending a corresponding signal when the light signal emitted from the display is detected, a light signal processing unit for processing signals sent from the light signal detecting module and generating a detection succeeded signal when the result of the processing shows the modulation of the light signals emitted by the display according to the predetermined rule is detected by the light signal detecting module, and a positioning unit for determining the position of the digitizer on the display according to the predetermined rule.

### BACKGROUND OF INVENTION

1. Field of the Invention

The present invention relates to a method for detecting a position of a digitizer on a display, and more particularly, to a method for detecting a position of a digitizer on a display according to a time at which the digitizer detects a predetermined modulation of light emitted from the display.

2. Description of the Prior Art

Digitizers are frequently utilized by systems such as personal digital assistants or notebook computers for locating and moving cursors. A display that utilizes a digitizer as a locating device needs to be equipped with functions and devices other than display related functions and devices. There are several kinds of methods for detecting a location of a digitizer on a display. Please refer to FIG. 1. FIG. 1 is a schematic diagram of a prior art system utilizing a digitizer 100 is a conventional system that utilizes a digitizer. System 100 includes a conventional digitizer 110 and a display 120. As illustrated in FIG. 1, a harmonic resonator 115 is included in the digitizer 110. The harmonic frequency of the resonator 115 is f₀. The display 120 generates waves. When the harmonic resonator 115 included in the digitizer 110 receives the waves generated by the display 120, the harmonic resonator 115 radiates waves of frequency f0. The induction circuit on the display 120 detects the location at which the harmonic resonator 115 radiates the waves of frequency f₀, and hence detects the location of the digitizer 110 on the display 120. Please refer to FIG. 2. FIG. 2 is a schematic diagram of another conventional system utilizing a digitizer. 200 is a conventional system that utilizes a digitizer. System 200 includes a conventional digitizer 210 and a display 220, wherein 222 and 226 are two short sides of the display 220, and 224 and 228 are two long sides of the display 220. The conventional system 200 is equipped with emitters along the short side 222 and the long side 224 for emitting light, and equipped with detectors along the short side 226 and the long side 228 for detecting light. When the digitizer 210 touches the display 220, the light emitted by the emitter which is located at the short side 222 of the same horizontal coordinate as the digitizer 210 is blocked by the digitizer 210. Accordingly the detector which is located at the short side 226 at the corresponding location cannot detect the light. Similarly, the light emitted by the emitter which is located at the long side 224 at the same vertical coordinate as the digitizer 210 is blocked by the digitizer 210. Therefore the detector which is located at the long side 228 at the corresponding location cannot detect the light either. In this way, the system 200 can detect the location of the digitizer 210 on the display 220.

The location of the digitizer can be accurately determined by the aforementioned conventional technology. However, the display device needs to be equipped with specialized functions and devices other than those required for the display function. Taking the system 100 illustrated in FIG. 1 for example, the display 120 has to be able to radiate waves so that the harmonic resonator 115 included in the digitizer 110 can radiate waves of frequency f₀. The display 120 further needs to be capable of detecting the waves radiated by the digitizer 110, so that the location of the digitizer on the display can be determined. As for the system 200 described in FIG. 2, the system 200 needs to be equipped with emitters and detectors on the sides of the display 220 for positioning the digitizer 210. These additional functions and devices certainly increase the complexity and cost of systems that utilize digitizers.

### SUMMARY OF INVENTION

It is therefore a primary objective of the claimed invention to provide a computer system capable of detecting a position of a digitizer on a display.

Briefly described, the claimed invention discloses a computer system capable of detecting a position of a digitizer on a display. The computer system includes a display, a graphics chip capable of controlling the display and modulating light signals emitted from a plurality of sub-blocks in a main block on the display sequentially according to a predetermined rule, a digitizer comprising a light signal detecting module which is capable of detecting a light signal emitted from the display and sending a corresponding signal when the light signal emitted from the display is detected, a light signal processing unit for processing signals sent from the light signal detecting module and generating a detection succeeded signal when the result of the processing shows the modulation of the light signals emitted by the display according to the predetermined rule is detected by the light signal detecting module, and a positioning unit for determining the position of the digitizer on the display according to the predetermined rule.

The claimed invention further discloses a digitizer. The digitizer includes a light signal detecting module capable of detecting a light signal emitted from a display and sending a corresponding signal when the light signal is detected, and a light signal processing unit for processing signals sent from the light signal detecting module and generating a detection succeeded signal when the result of the processing shows the modulation of the light signal emitted by the display according to a predetermined rule is detected by the light signal detecting module.

The claimed invention further discloses a method for detecting a position of a digitizer on a display, wherein the digitizer comprises a light signal detecting module capable of detecting a light signal emitted from the display. The method includes modulating light signals emitted from each of a plurality of sub-blocks in a main block on the display sequentially according to a predetermined rule, generating a detection succeeded signal when the modulation is detected by the light signal detecting module, and detecting the position of the digitizer on the display according to a time at which the detection succeeded signal is generated.

It is an advantage of the claimed invention that the display does not need to be equipped substantial additional hardware. In the claimed invention, the display only needs the graphic chip to support emitting the modulated light, and hence the cost of the system is decreased and the structure of the system is simplified.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a prior art system utilizing a digitizer.

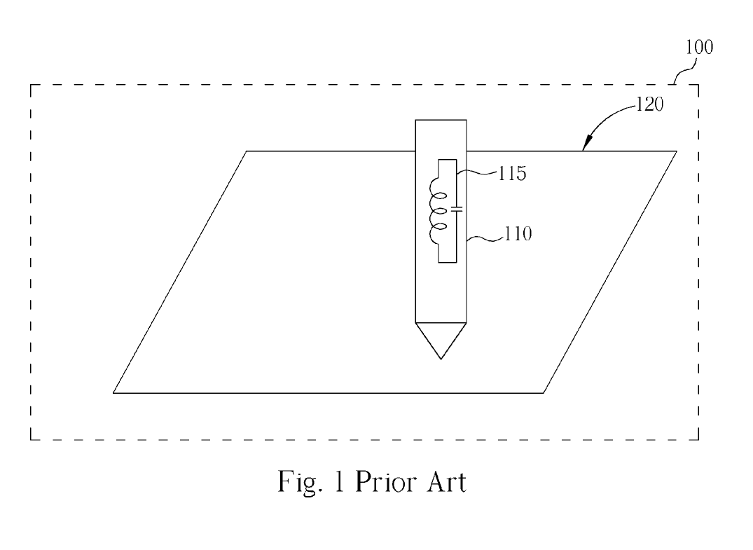

FIG. 2 is a schematic diagram of another prior art system utilizing a digitizer.

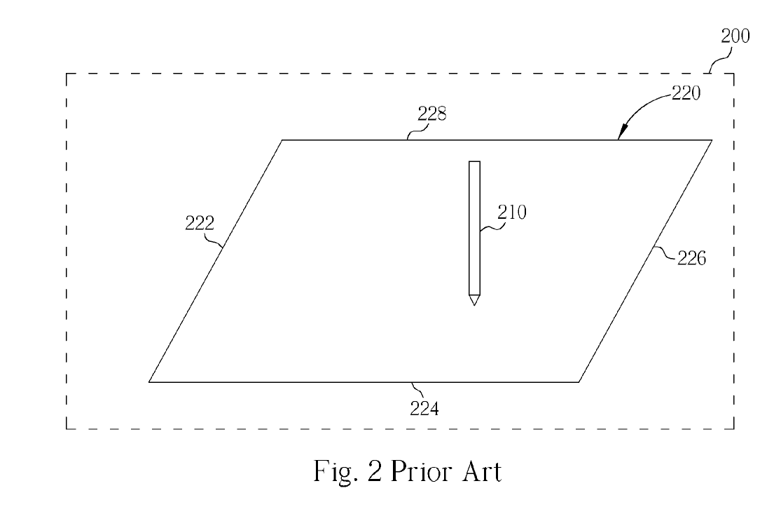

FIG. 3 is a schematic diagram of the present invention computer system.

FIG. 4 is a schematic diagram of a first embodiment of the present invention computer system detecting a location of the digitizer.

FIG. 5 is a flowchart of the first embodiment of the present invention computer system detecting a location of the digitizer.

FIG. 6 is a flowchart of a second embodiment of the present invention computer system detecting a location of the digitizer.

### DETAILED DESCRIPTION

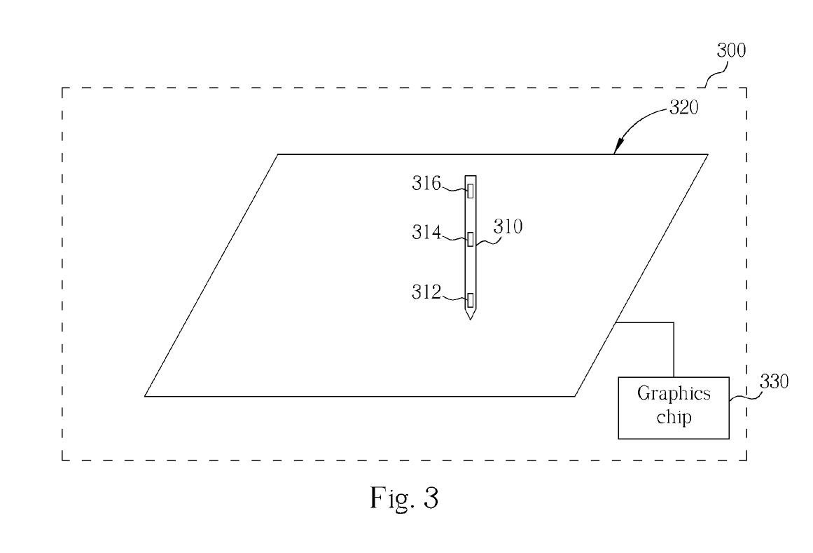

Please refer to FIG. 3. FIG. 3 is a schematic diagram of the present invention computer system 300. The computer system 300 includes a display 320, a graphics chip 330 for controlling the display 320, and a digitizer 310. The digitizer 310 comprises a light signal detecting module 312, a light signal processing unit 314, and a positioning unit 316. The light signal detecting module 312 is capable of detecting a light signal emitted from the display 320 and sending a corresponding signal when the light signal emitted from the display 320 is detected. The light signal processing unit 314 is capable of processing signals sent from the light signal detecting module 312. The positioning unit 316 is for determining the position of the digitizer 310 on the display 320 according to a predetermined rule. In the present invention, the graphics chip 330 modulates light signals emitted from a plurality of sub-blocks in a main block on the display 320 sequentially according to a predetermined rule. When the light signal processing unit 314 processes the signals sent from the light signal detecting module 312 and detects that the light emitted by the display 320 is modulated according to the predetermined rule, the light signal processing unit 314 generates a detection succeeded signal, and the positioning unit 316 detects the position of the digitizer 310 on the display 320 according to the detection succeeded signal and the predetermined rule.

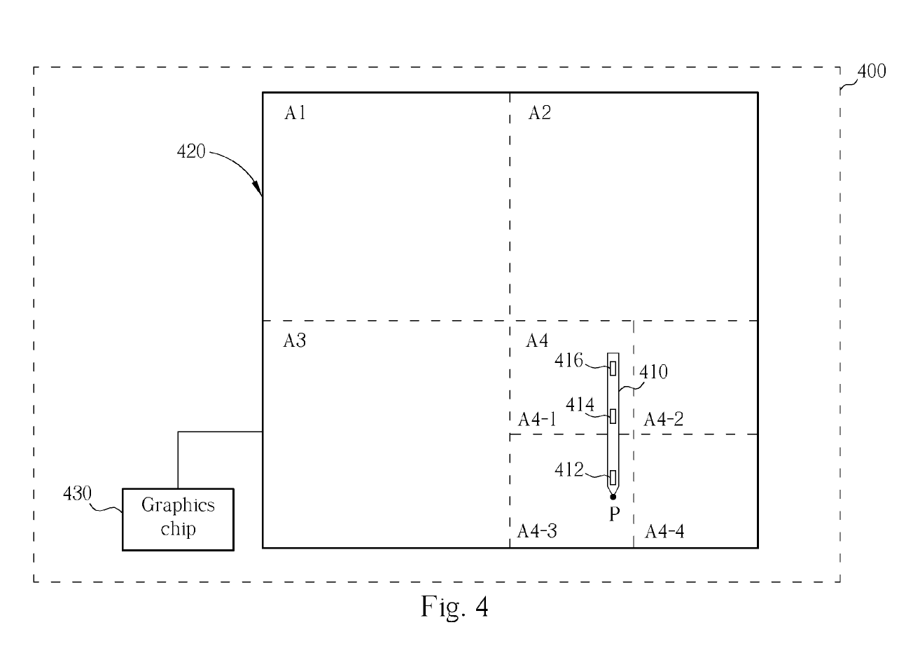

The aforementioned detection can be performed in stratification. Please refer to FIG. 4. FIG. 4 is a schematic diagram of a first embodiment of the present invention computer system 400 detecting a location of the digitizer. The computer system 400 includes a display 420, a graphics chip 430, and a digitizer 410. The digitizer 410 comprises a light signal detecting module 412, a light signal processing unit 414, and a positioning unit 416. According the predetermined rule, the graphics chip 430 sets the four sub-blocks A₁, A₂, A₃ and A₄ of the display 420 as the target block sequentially, and adds and subtracts a predetermined amount of strength, C1, to/from the strength of the light signals emitted from the target block alternately with a predetermined frequency f within a predetermined period D1. As illustrated in FIG. 4, the area of each of the sub-blocks A₁, A₂, A₃ and A₄ is a quarter of the area of the display 420. If Bt′ represents the strength of the unmodulated light signal emitted from the target block, and Bt′ represents the strength of the light signal modulated according to the predetermined rule emitted by the target block, then
Bt′=Bt+C1·z(t),

$$z ( t ) = \{ \begin{matrix}1 , & 0 < 2 f t < 1 , 2 < 2 f t < 3 , … , ( f D - 2 ) < 2 f t < ( f D - 1 ) \\ - 1 , & 1 < 2 f t < 2 , 3 < 2 f t < 4 , … , ( f D - 1 ) < 2 f t < f D\end{matrix} .$$

C1 is a constant and represents the variation of the strength of light signals. C1 can be well designed such that the variation cannot be observed by naked eyes. Assume C1 is 2, f is 100 Hz, and D is 0.1 second, and take B₁, B₂, B₃ and B₄ as the strength of the unmodulated light signals emitted from the respective sub-block A₁, A₂, A₃ and A₄, and B₁′, B₂′, B₃′ and B₄′ as the strength of the light signal modulated by the graphics chip according to the predetermined rule emitted from the respective sub-block A₁, A₂, A₃ and A₄. From the modulation time, the strengths of the light signals emitted from the sub-block A₁, A₂, A₃ and A₄ are:
when 0<t≦0.1

$$\begin{matrix}{B}_{1}^{′} = \{ \begin{matrix}{B}_{1} + 2 , & 0.00 < t \leq 0.01 , 0.02 < t \leq 0.03 , … , 0.08 < t \leq 0.09 \\ {B}_{1} - 2 , & 0.01 < t \leq 0.02 , 0.03 < t \leq 0.04 , … , 0.09 < t \leq 0.10\end{matrix} ; \\ {B}_{2}^{′} = {B}_{2} ; \\ {B}_{3}^{′} = {B}_{3} ; \\ {B}_{4}^{′} = {B}_{4} ;\end{matrix}$$

when 0.1<t≦0.2

$$\begin{matrix}{B}_{1}^{′} = {B}_{1} ; \\ {B}_{2}^{′} = \{ \begin{matrix}{B}_{2} + 2 , & 0.10 < t \leq 0.11 , 0.12 < t \leq 0.13 , … , 0.18 < t \leq 0.19 \\ {B}_{2} - 2 , & 0.11 < t \leq 0.12 , 0.13 < t \leq 0.14 , … , 0.19 < t \leq 0.20\end{matrix} ; \\ {B}_{3}^{′} = {B}_{3} ; \\ {B}_{4}^{′} = {B}_{4} ;\end{matrix}$$

when 0.2<t≦0.4

$$\begin{matrix}{B}_{1}^{′} = {B}_{1} ; \\ {B}_{2}^{′} = {B}_{2} ; \\ {B}_{3}^{′} = \{ \begin{matrix}{B}_{3} + 2 , & 0.20 < t \leq 0.21 , 0.22 < t \leq 0.23 , … , 0.28 < t \leq 0.29 \\ {B}_{3} - 2 , & 0.21 < t \leq 0.22 , 0.23 < t \leq 0.24 , … , 0.29 < t \leq 0.30\end{matrix} ; \\ {B}_{4}^{′} = {B}_{4} ;\end{matrix}$$

when 0.3<t≦0.4

$$\begin{matrix}{B}_{1}^{′} = {B}_{1} ; \\ {B}_{2}^{′} = {B}_{2} ; \\ {B}_{3}^{′} = {B}_{3} ; \\ {B}_{4}^{′} = \{ \begin{matrix}{B}_{4} + 2 , & 0.30 < t \leq 0.31 , 0.32 < t \leq 0.33 , … , 0.38 < t \leq 0.39 \\ {B}_{4} - 2 , & 0.31 < t \leq 0.32 , 0.33 < t \leq 0.34 , … , 0.39 < t \leq 0.40\end{matrix} .\end{matrix}$$
wherein the unit of t is second.

As illustrated in FIG. 4, the point P that is pointed to by the digitizer 410 on the display 420 is located in the sub-block A₄. Therefore the light signal processing unit 414 detects the modulation of the strength of the light signals of which the frequency is 100 Hz and the magnitude is 2 according to the predetermined rule from 0.3 sec to 0.4 sec when the light signal processing unit 414 processes the signals from the light signal detecting module 412. Thereupon the light signal processing unit 414 generates a detection succeeded signal. The positioning unit 416 records that the digitizer 410 is located in the sub-block A₄ in the first layer of the positioning according to the time at which the detection succeeded signal is generated.

After the first-layer positioning is done, the graphics chip 430 starts the second-layer positioning. The block A₄ is set as the main block in the second-layer positioning. Each of four sub-blocks A₄₋₁, A₄₋₂, A₄₋₃ and A₄₋₄ of the block A₄ on the display 420 is set as the target block sequentially. The light signals from the target block are modulated as aforementioned. Take B₄₋₁, B₄₋₂, B₄₋₃ and B₄₋₄ as the strength of the unmodulated light signals emitted from the sub-block A₄₋₁, A₄₋₂, A₄₋₃ and A₄₋₄, and B₄₋₁′, B₄₋₂′, B₄₋₃′ and B₄₋₄′ as the strength of the light signal modulated according to the predetermined rule emitted from the respective sub-block A₄₋₁, A₄₋₂, A₄₋₃ and A₄₋₄. From the modulation time, the strengths of the light signals emitted from the sub-block 4-1, A₄₋₂, A₄₋₃ and A₄₋₄ are:
when 0<t≦0.1

$$\begin{matrix}{B}_{4 - 1}^{′} = \{ \begin{matrix}{B}_{4 - 1} + 2 , & 0.00 < t \leq 0.01 , 0.02 < t \leq 0.03 , … , 0.08 < t \leq 0.09 \\ {B}_{4 - 1} - 2 , & 0.01 < t \leq 0.02 , 0.03 < t \leq 0.04 , … , 0.09 < t \leq 0.10\end{matrix} ; \\ {B}_{4 - 2}^{′} = {B}_{4 - 2} ; \\ {B}_{4 - 3}^{′} = {B}_{4 - 3} ; \\ {B}_{4 - 4}^{′} = {B}_{4 - 4} ;\end{matrix}$$

when 0.1<t≦0.2

$$\begin{matrix}{B}_{4 - 1}^{′} = {B}_{4 - 1} ; \\ {B}_{4 - 2}^{′} = \{ \begin{matrix}{B}_{4 - 2} + 2 , & 0.10 < t \leq 0.11 , 0.12 < t \leq 0.13 , … , 0.18 < t \leq 0.19 \\ {B}_{4 - 2} - 2 , & 0.11 < t \leq 0.12 , 0.13 < t \leq 0.14 , … , 0.19 < t \leq 0.20\end{matrix} ; \\ {B}_{4 - 3}^{′} = {B}_{4 - 3} ; \\ {B}_{4 - 4}^{′} = {B}_{4 - 4} ;\end{matrix}$$

when 0.3<t≦0.3

$$\begin{matrix}{B}_{4 - 1}^{′} = {B}_{4 - 1} ; \\ {B}_{4 - 2}^{′} = {B}_{4 - 2} ; \\ {B}_{4 - 3}^{′} = \{ \begin{matrix}{B}_{4 - 3} + 2 , & 0.20 < t \leq 0.21 , 0.22 < t \leq 0.23 , … , 0.28 < t \leq 0.29 \\ {B}_{4 - 3} - 2 , & 0.21 < t \leq 0.22 , 0.23 < t \leq 0.24 , … , 0.29 < t \leq 0.30\end{matrix} ; \\ {B}_{4 - 4}^{′} = {B}_{4 - 4} ;\end{matrix}$$

when 0.3<t≦0.4

$$\begin{matrix}{B}_{4 - 1}^{′} = {B}_{4 - 1} ; \\ {B}_{4 - 2}^{′} = {B}_{4 - 2} ; \\ {B}_{4 - 3}^{′} = {B}_{4 - 3} ; \\ {B}_{4 - 4}^{′} = \{ \begin{matrix}{B}_{4 - 4} + 2 , & 0.30 < t \leq 0.31 , 0.32 < t \leq 0.33 , … , 0.38 < t \leq 0.39 \\ {B}_{4 - 4} - 2 , & 0.31 < t \leq 0.32 , 0.33 < t \leq 0.34 , … , 0.39 < t \leq 0.40\end{matrix} ;\end{matrix}$$

wherein the unit of t is second.

Please refer to FIG. 4. As demonstrated in FIG. 4, the point P is located in the sub-block A₄-3, Therefore the light signal processing unit 414 detects the modulation of the strength of the light signals of which the frequency is 100 Hz and the magnitude is 2 according to the predetermined rule from 0.2 sec to 0.3 sec when the light signal processing unit 414 processes the signals from the light signal detecting module 412. Thereupon the light signal processing unit 414 generates a detection succeeded signal. The positioning unit 416 records that the digitizer 410 is located in the sub-block A₄₋₃ in the second layer of the positioning according to the time at which the detection succeeded signal is generated.

Similarly, the graphics chip 430 starts the third-layer positioning after the second-layer positioning is done. The block A₄₋₃ is set as the main block in the third-layer positioning. Each of the four sub-blocks of the block A₄₋₃ on the display 420 is set as the target block sequentially and the light signals from the target block are modulated as aforementioned. Following the pattern, the graphics chip 430 performs the positioning layer by layer as many times (i.e. iterates) as the predetermined rule orders. For example, if the predetermined rule orders a seven-layer positioning, the position of the point P pointed out by the digitizer 410 on the display 420 is therefore determined by the summation of seven data of the time at which the detection succeeded signals are generated. The predetermined rule in the present system and the related method can be designed such that when the detection succeeded signal is generated, the positioning procedure of the current layer is interrupted and the positioning procedure of next layer starts right away for saving processing time. The number of the sub-blocks of each layer can be optimized on a case-by-case scenario. Furthermore, if all sub-blocks have been set as the main block and light signals emitted by them are modulated according to the predetermined rule but the sub-block in which the digitizer is located is still unknown, the positioning procedure of that layer will be performed repeatedly until the result of the positioning is obtained. In the aforementioned embodiment, the strength of the light signal is modulated. However, in the present invention, the saturation or other parameters of the light signals emitted from the target block can be modulated instead. Likewise, the more invisible this method is, the better these overall positioning effect is.

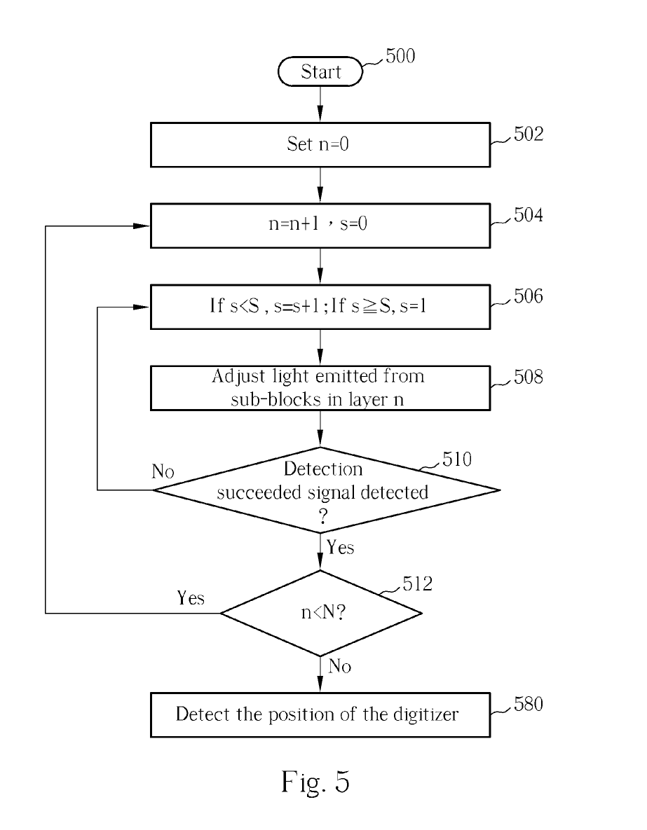

Please refer to FIG. 5. FIG. 5 is a flowchart of the first embodiment of the present invention computer system detecting a location of a digitizer. In this embodiment, the layers of positioning is assumed N, and the number of sub-blocks in each layer is assumed S. Variables n and s are taken to represent the current layer and the current main block in the system.
Step 500: Start;
Step 502: Set n as 0;
Step 504: Increase n by 1 and set s as 0;
Step 506: If s is less than S, increase s by 1; otherwise set s as 1;
Step 508: Set the block s in the layer n as the target block, and modulate the light signals emitted from the target block according to the predetermined rule;
Step 510: Process the signals from the light signal detecting module; if the light signals emitted from the target block are found modulated according to the predetermined rule, generate the detection succeeded signal and record the time at which the detection succeeded signal is generated and then perform Step 512;
Step 512: If n is less than N, perform Step 504; otherwise perform Step 570;
Step 580: Determine the position of the digitizer on the display according to the predetermined rule and every time at which the detection succeeded signal is generated.

Generally, the positioning of the digitizer has to be maintained continuously, which means when the position of the digitizer on the display is obtained in Step 580, the claimed system will restart from Step 502 and repeat the procedures for keeping track of the digitizer on the display.

There are variations in different embodiments of the present invention. For instance, the X coordinate and the Y coordinate of the digitizer on the display can be detected separately. In the second embodiment, a plurality of sub-blocks are classified by X coordinates and each sub-block is set as a target block sequentially. The graphics chip is capable of modulating the strength of light signals emitted from the target block by adding a value C2 to the strength of the light signals emitted from the target block for a period of time, D2. Another plurality of sub-blocks are classified by Y coordinates and each sub-block is set as a target block sequentially. The graphics chip is capable of modulating the strength of light signals emitted from the target block by adding a value C3 to the strength of the light signals emitted from the target block for a period of time, D3, as well. When the light signal processing unit processes the signals from the light signal detecting module and finds the light signals are modulated with a magnitude C2 and a duration D2 according to the predetermined rule, the light signal processing unit generates an X signal. Similarly, when the light signal processing unit processes the signals from the light signal detecting module and finds the light signals are modulated with a magnitude C3 and a duration D3 according to the predetermined rule, the light signal processing unit generates a Y signal. The positioning unit utilizes the times at which the X signal and the Y signal are generated to determine the X coordinate and the Y coordinate of the digitizer on the display, and determines the position pointed to by the digitizer on the display as a result.

The details of the second embodiment of the claimed invention are described as follows. Looking at the X direction first, assume D2 is 0.01 second, divide the display into L intervals along the X-axis according to the predetermined rule, and represent the strength of the unmodulated light signals emitted from the interval₁ by x(l) and the strength of the modulated light signals emitted from the interval₁ by x′(l). From the modulation time, the strengths of the light signals emitted from the blocks classified by X coordinates are:
when 0<t≦0.01

$$\begin{matrix}{x}^{′} ( 1 ) = x ( 1 ) + C2 ; \\ {x}^{′} ( 2 ) = x ( 2 ) ; \\ {x}^{′} ( 3 ) = x ( 3 ) ; \\ ⋮ \\ {x}^{′} ( L ) = x ( L ) ;\end{matrix}$$

when 0.01<t≦0.02

$$\begin{matrix}{x}^{′} ( 1 ) = x ( 1 ) ; \\ {x}^{′} ( 2 ) = x ( 2 ) + C2 ; \\ {x}^{′} ( 3 ) = x ( 3 ) ; \\ ⋮ \\ {x}^{′} ( L ) = x ( L ) ; \\ ⋮\end{matrix}$$

when 0.01·(L−1)<t≦0.01·L

$$\begin{matrix}{x}^{′} ( 1 ) = x ( 1 ) ; \\ {x}^{′} ( 2 ) = x ( 2 ) ; \\ {x}^{′} ( 3 ) = x ( 3 ) ; \\ ⋮ \\ {x}^{′} ( L ) = x ( L ) + C2 ;\end{matrix}$$

wherein the unit of t is second.
Looking at the Y direction, assume D3 is 0.01 second, divide the display into M intervals along the Y-axis according to the predetermined rule, and represent the strength of the unmodulated light signals emitted from the interval m by y(m) and the strength of the modulated light signals emitted from the interval m by y′(m). From the modulation time, the strengths of the light signals emitted from the blocks classified by Y coordinates are:
when 0<t≦0.01

$$\begin{matrix}{y}^{′} ( 1 ) = y ( 1 ) + C3 ; \\ {y}^{′} ( 2 ) = y ( 2 ) ; \\ {y}^{′} ( 3 ) = y ( 3 ) ; \\ ⋮ \\ {y}^{′} ( M ) = y ( M ) ;\end{matrix}$$

when 0.0<t≦0.02

$$\begin{matrix}{y}^{′} ( 1 ) = y ( 1 ) ; \\ {y}^{′} ( 2 ) = y ( 2 ) + C3 ; \\ {y}^{′} ( 3 ) = y ( 3 ) ; \\ ⋮ \\ {y}^{′} ( M ) = y ( M ) ; \\ ⋮\end{matrix}$$

when 0.01·(M−1)<t≦0.01·M

$$\begin{matrix}{y}^{′} ( 1 ) = y ( 1 ) ; \\ {y}^{′} ( 2 ) = y ( 2 ) ; \\ {y}^{′} ( 3 ) = y ( 3 ) ; \\ ⋮ \\ {y}^{′} ( M ) = y ( M ) + C3 ;\end{matrix}$$
wherein the unit of t is second.

If the light signal processing unit finds the strength of the light signals are being modulated with a magnitude C2 and a duration D2 according to the predetermined rule within time (0.01·(J−1)) second to (0.01·J) second when the light signal processing unit processes the signals from the light signal detecting module, the light signal processing unit generates an X signal. And if the light signal processing unit finds the strength of the light signals are being modulated with a magnitude C3 and a duration D3 according to the predetermined rule within time (0.01 (K−1)) second to (0.01·K) second when the light signal processing unit processes the signals from the light signal detecting module, the light signal processing unit generates a Y signal. The positioning unit records that the digitizer is located in the sub-block J in the X direction and in the sub-block K in the Y direction, and therefore the position of the digitizer is obtained. In addition, not only the strength of the light signals but also the saturation or other parameters of the light signals can be modulated according to a predetermined rule in different embodiments of the present invention. The modulation selected should be invisible to users.

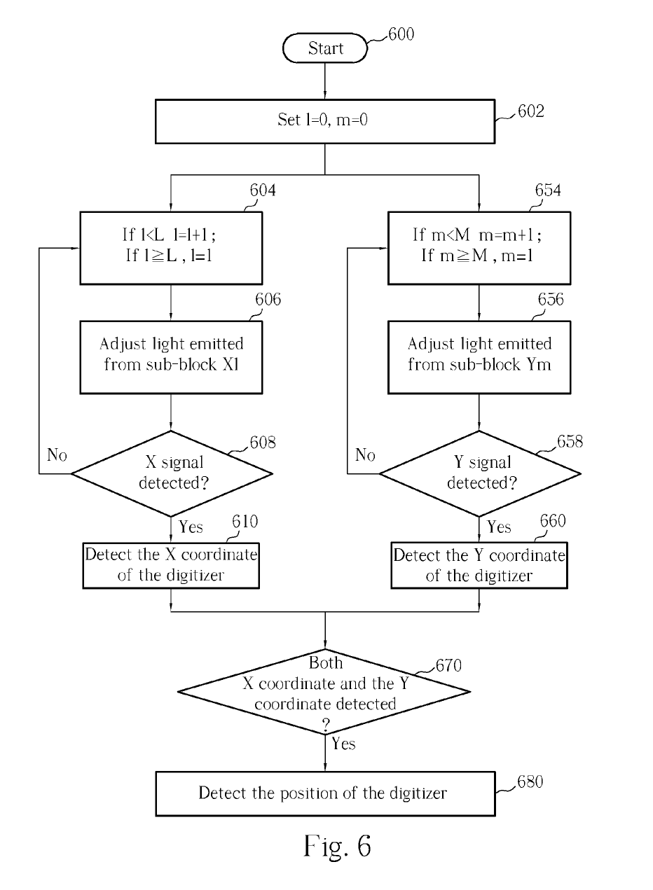

Please refer to FIG. 6. FIG. 6 is a flowchart of a second embodiment of the present invention computer system detecting a location of the digitizer. In the second embodiment, the X coordinate and the Y coordinate of the position of the digitizer are obtained separately. Assume the display is divided into L intervals along the X-axis and divided into M intervals along the Y-axis according to the predetermined rule.
Step 600: Start;
Step 602: Set l as 0 and m as 0; perform Step 604 and Step 654;
Step 604: If l is less than L, increase l by 1; otherwise set l as 1;
Step 606: Set the block of which the X coordinates are within the interval l as the target block, and modulate the light signals emitted from the target block according to the predetermined rule;
Step 608: Process the signals from the light signal detecting module; if it is found that the light signals emitted from the target block are modulated according to the predetermined rule, generate an X signal and record the time at which the X signal is generated and then perform Step 610; otherwise perform Step 604;
Step 610: Determine the X coordinate of the position pointed to by the digitizer on the display according to the time at which the X signal is generated by the predetermined rule; perform Step 670;
Step 654: If m is less than M, increase m by 1; otherwise set m as 1;
Step 656: Set the block of which the Y coordinates are within the interval m as the target block, and modulate the light signals emitted from the target block according to the predetermined rule;
Step 658: Process the signals from the light signal detecting module; if it is found that the light signals emitted from the target block are modulated according to the predetermined rule, generate a Y signal and record the time at which the Y signal is generated and then perform Step 660; otherwise perform Step 654;
Step 660: Determine the Y coordinate of the position pointed to by the digitizer on the display according to the time at which the Y signal is generated by the predetermined rule; perform Step 670;
Step 670: If the X coordinate and the Y coordinate of the digitizer are both obtained, perform Step 680;
Step 680: Determine the position of the digitizer on the display according to the X coordinate and the Y coordinate.

As illustrated in FIG. 6, in the second embodiment of the present invention, obtaining the X coordinate and the Y coordinate of the digitizer on the display may be two independent processes. When the X coordinate is obtained, the logic unit checks if both of the X coordinate and the Y coordinate are obtained. If so, the X coordinate and the Y coordinate are combined to determine the position of the digitizer on the display. Contrarily, if only the X coordinate is obtained but the Y coordinate is not, the method pauses at Step 670 and waits until the Y coordinate is obtained, the Step 670 is accordingly performed and then obtaining the X coordinate is ensured. Afterward, the Step 680 is performed and the position of the digitizer on the display is determined. As the first embodiment described in FIG. 5, the positioning of the digitizer in the second embodiment of the present invention can be maintained continuously, which means when the position of the digitizer on the display is obtained in Step 680, the system will restart from Step 602 and repeat the procedures for keeping track of the digitizer on the display. The method of the second embodiment can also be performed in stratification (i.e. by iteration).

In the above description, the light signal processing unit and the positioning unit are included in the digitizer. However, in the claimed system, the light signal processing unit or the positioning unit may be included in the host system instead of the digitizer, or both the light signal processing unit and the positioning unit can be included in the host system but not the digitizer. The light signal processing unit included in the digitizer and the positioning unit are connected by wire or wirelessly for transmitting the signals. Furthermore, the digitizer of the present invention may includes a mouse module for controlling a cursor on the display and performing a click function. In that case, the digitizer of the present invention may comprise the function of absolute positioning and the function of relative positioning simultaneously. The digitizer may further include a switching module for switching the mouse module and the light signal detecting module. If the mouse module included in the claimed digitizer is an optical mouse module, the light signal detecting module can be utilized by the optical mouse module, too. The switching module may be an auto-switching module for turning off the optical mouse module when a light signal emitted from the display is detected by the light detecting module, and turning on the optical mouse module when no light signal emitted from the display is detected by the light signal detecting module.

The system and related method of the present invention detect the position of a digitizer on a display by adjusting the light signals emitted from a plurality of blocks on the display according to a predetermined rule. The display in the present invention does not need to be equipped with functions and devices other than displaying but only needs to provide a graphics chip capable of controlling the display to modulate the light signals according to the predetermined rule. Therefore the structure of the system which utilizes a digitizer may be simplified and the cost is decreased correspondingly. If an optical mouse module is further included in the digitizer of the present invention, the light signal detecting module can be utilized by the optical mouse module, too. Hence the structure of the device can be further simplified and the cost reduced accordingly. The system of the present invention may be a notebook computer, a desktop computer, a personal digital assistant, a tablet PC, an electronic translator or other computer system.

Those skilled in the art will readily observe that numerous modifications and alterations of the device may be made while retaining the teachings of the invention. Accordingly, the above disclosure should be construed as limited only by the metes and bounds of the appended claims.

1. A method for detecting a position of a digitizer on a display, wherein the digitizer comprises a light signal detecting module capable of detecting a light signal emitted from the display, the method comprising:
(a) modulating light signals emitted from each of a plurality of sub-blocks in a main block on the display sequentially according to a predetermined rule;
(b) generating a detection succeeded signal when the modulation is detected by the light signal detecting module; and
(c) detecting the position of the digitizer on the display according to a time at which the detection succeeded signal is generated.

2. The method of claim 1 wherein each sub-block in the plurality of sub-blocks is set as a target block sequentially, and a predetermined amount of strength is added to and subtracted from the strength of the light signal emitted from the target block alternately with a predetermined frequency within a predetermined period in step (a).

3. The method of claim 1 further comprising:
(d) adding a first value to a parameter when the detection succeeded signal is generated, and storing information corresponding to the time at which the detection succeeded signal is generated; and
(e) if the parameter is not bigger than a second value, setting a sub-block corresponded to the information as a main block, modulating light signals emitted from each of a plurality of sub-blocks in the main block sequentially according to the predetermined rule, and generating a detection succeeded signal when the modulation is detected by the light signal detecting module; otherwise detecting the position of the digitizer on the display according to all the information that is stored.

4. The method of claim 1 wherein a plurality of sub-blocks are classified by X coordinates and each sub-block is set as a target block sequentially, wherein the graphic chip is capable of modulating a strength of a light signal emitted from the target block by adding a third value to the strength of the light signal emitted from the target block for a period of time, t1, and another plurality of sub-blocks are classified by Y coordinates and each sub-block is set as a target block sequentially, wherein the graphic chip is capable of modulating a strength of a light signal emitted from the target block by adding a fourth value to the strength of the light signal emitted from the target block for a period of time, t2, in step (a).

5. The method of claim 4 in which the detection succeeded signal comprises an X signal and a Y signal, wherein the X signal is generated when the change of the strength of the third value which lasts for the t1 period of time is detected by the light signal detecting module, and the Y signal is generated when the change of strength of the fourth value which lasts for the t2 period of time is detected by the light signal detecting module, and the position of the digitizer on the display is detected according to a time at which the X signal is generated and a time at which the Y signal is generated in step (c).

6. A computer system capable of detecting a position of a digitizer on a display comprising:
a display;
a graphics chip capable of controlling the display and modulating light signals emitted from a plurality of sub-blocks in a main block on the display sequentially according to a predetermined rule;
a digitizer comprising a light signal detecting module, wherein the light signal detecting module is capable of detecting a light signal emitted from the display and sending a corresponding signal when the light signal emitted from the display is detected;
a light signal processing unit for processing signals sent from the light signal detecting module and generating a detection succeeded signal when the result of the processing shows the modulation of the light signals emitted by the display according to the predetermined rule is detected by the light signal detecting module; and
a positioning unit for determining the position of the digitizer on the display according to the predetermined rule.

7. The computer system of claim 6 wherein the graphics chip sets each sub-block in the plurality of sub-blocks as a target block sequentially, and modulates light signals emitted from the target block by adding a predetermined amount of strength to a strength of the light signals emitted from the target block and subtracting the predetermined amount of strength to the strength of the light signals emitted from the target block alternately with a predetermined frequency within a predetermined period.

8. The computer system of claim 6 wherein the positioning unit is further capable of adding a first value to a parameter when the detection succeeded signal is generated, and storing information corresponding to a time at which the detection succeeded signal is generated, and detecting the position of the digitizer on the display according to all the information that is stored when the parameter is bigger than a second value.

9. The computer system of claim 8 wherein the graphics chip is further capable of setting a sub-block which is corresponded to the information as a main block and modulating light signals emitted from a plurality of sub-blocks in the main block sequentially according to the predetermined rule when the parameter is not bigger than the second value.

10. The computer system of claim 6 wherein a plurality of sub-blocks are classified by X coordinates and each sub-block is set as a target block sequentially, wherein the graphics chip is capable of modulating a strength of light signals emitted from the target block by adding a third value to the strength of the light signals emitted from the target block for a period of time, t1, and another plurality of sub-blocks are classified by Y coordinates and each sub-block is set as a target block sequentially, wherein the graphic chip is capable of modulating a strength of light signals emitted from the target block by adding a fourth value to the strength of light signals emitted from the target block for a period of time, t2.

11. The computer system of claim 10 in which the detection succeeded signal comprises an X signal and a Y signal, wherein the light signal processing unit is capable of generating the X signal when the change of strength of the third value which lasts for the t1 period of time is detected by the light signal detecting module, and generating the Y signal when the change of strength of the fourth value is detected which lasts for the t2 period of time by the light signal detecting module, and the positioning unit is capable of determining the position of the digitizer on the display according to a time at which the X signal is generated and a time at which the Y signal is generated.

12. The computer system of claim 6 wherein the light signal processing unit is included in the digitizer.

13. The computer system of claim 6 wherein the light signal processing unit and the positioning unit are included in the digitizer.

14. The computer system of claim 6 wherein the light signal processing unit and the positioning unit are included in one chip.

15. The computer system of claim 6 wherein the light signal processing unit and the positioning unit are connected wirelessly.

16. The computer system of claim 6 wherein the light signal processing unit and the positioning unit are connected by wire.

17. The computer system of claim 6 wherein the digitizer further comprises a mouse module for controlling a cursor on the display and performing a click function.

18. The computer system of claim 17 wherein the digitizer further comprises a switching module for switching the mouse module and the light signal detecting module.

19. The computer system of claim 17 wherein the mouse module is an optical mouse module, the digitizer further comprising an auto-switching module for turning off the optical mouse module when a light signal emitted from the display is detected by the light detecting module, and turning on the optical mouse module when no light signal emitted from the display is detected by the light signal detecting module.

20. The computer system of claim 6 being a personal digital assistant (PDA).

21. The computer system of claim 6 being a notebook computer.

22. The computer system of claim 6 being an electronic translator.

23. The computer system of claim 6 being a desktop computer.

24. The computer system of claim 6 being a tablet PC.

25. A digitizer comprising:
a light signal detecting module capable of detecting a light signal emitted from a display and sending a corresponding signal when the light signal is detected; and
a light signal processing unit for processing signals sent from the light signal detecting module and generating a detection succeeded signal when the result of the processing shows the modulation of the light signal emitted by the display according to a predetermined rule is detected by the light signal detecting module.

26. The digitizer of claim 25 further comprising:
a positioning unit for determining a position of the digitizer on the display according to the predetermined rule.

27. The digitizer of claim 26 wherein the light signal processing unit and the positioning unit are included in one chip.

28. The digitizer of claim 25 further comprising a mouse module for controlling a cursor on the display and performing a click function.

29. The digitizer of claim 28 further comprising a switching module for switching the mouse module and the light signal detecting module.

30. The digitizer of claim 28 wherein the mouse module is an optical mouse module, the digitizer further comprising an auto-switching module for turning off the optical mouse module when a light signal emitted from the display is detected by the light signal detecting module, and turning on the optical mouse module when no light signal emitted from the display is detected by the light signal detecting module.
